(19) United States
(12) Patent Application Publication
(10) Pub. No.: US 2021/0328264 A1
(43) Pub. Date: Oct. 21, 2021

(54) COMPOSITE ELECTROLYTE, METHOD FOR MANUFACTURING THE SAME AND BATTERY

(71) Applicant: National Cheng Kung University, Tainan City (TW)

(72) Inventors: Sheng-Shu Hou, Tainan City (TW); Hsi-Sheng Teng, Tainan City (TW); Po-Han Lee, Taichung City (TW); Hung-Che Chang, Yilan County (TW)

(21) Appl. No.: 17/076,758

(22) Filed: Oct. 21, 2020

(30) Foreign Application Priority Data
Apr. 16, 2020 (TW) 109112761

(51) Int. Cl. H01M 10/0565; H01M 10/0525; H01M 10/0569; H01M 4/36; H01M 4/04

(52) U.S. Cl. CPC H01M 10/0565; H01M 10/0525; H01M 4/0433; H01M 4/364; H01M 4/0471; H01M 10/0569

(57) ABSTRACT

A method for manufacturing a composite electrolyte includes steps as follows. A eutectic mixture is provided. The eutectic mixture includes a lithium salt and a hydrogen-bond donor. The lithium salt includes a hydrogen-bond acceptor. A polymer material is provided. The polymer material includes a polymer. A mixing step is conducted. The eutectic mixture and the polymer material are mixed and heated to form an electrolyte precursor. A molding step is conducted. The electrolyte precursor is cooled to obtain the composite electrolyte.

### BACKGROUND OF THE INVENTION

### 1. Field of the Invention

The present disclosure relates to a composite electrolyte, method for manufacturing the same and battery having the same, and more particularly, to a composite electrolyte manufactured by a eutectic mixture and a polymer material, method for manufacturing the same and battery having the same.

### 2. Description of the Prior Art

With the popularity of portable electronic products, the development of rechargeable batteries is promoted. Among various types of rechargeable batteries, lithium-ion batteries, having high energy density and no memory effect, are widely used.

A traditional lithium-ion battery includes a negative electrode, a positive electrode, and a liquid electrolyte for delivering lithium ions. The liquid electrolyte is a liquid organic solvent, which could cause problems such as liquid leakage and explosion. Moreover, when the lithium-ion battery is wasted, the organic solvent of the lithium-ion battery may pollute the environment.

For avoiding the drawbacks of the traditional lithium-ion batteries, lithium-ion polymer batteries are developed, in which a colloidal or solid polymer electrolyte is provided to replace the liquid electrolyte. However, the polymer electrolyte is manufactured by dissolving a lithium salt with an organic solvent, such as ethylene carbonate (EC) or propylene carbonate (PC), to forma viscous solution under high temperature. Afterwards, the viscous solution is cooled to obtain the polymer electrolyte. EC and PC are expensive. Further, the process temperature is usually greater than 100° C., which is energy-consuming. Accordingly, it is unfavorable for reducing the manufacturing cost of the lithium-ion polymer batteries.

### SUMMARY OF THE INVENTION

According to one embodiment of the present disclosure, a method for manufacturing a eutectic mixture includes steps as follows. A eutectic mixture is provided, wherein the eutectic mixture includes a lithium salt and a hydrogen-bond donor, and the lithium salt includes a hydrogen-bond acceptor. A polymer material is provided, wherein the polymer material includes a polymer. A mixing step is conducted, wherein the eutectic mixture and the polymer material are mixed and heated to form an electrolyte precursor. A molding step is conducted, wherein the electrolyte precursor is cooled to obtain the composite electrolyte.

According to another embodiment of the present disclosure, a composite electrolyte is provided. The composite electrolyte is manufactured by the aforementioned method.

According to yet another embodiment of the present disclosure, a battery is provided. The battery includes a positive electrode, a negative electrode, and the aforementioned composite electrolyte. The composite electrolyte is disposed between the positive electrode and the negative electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram showing a method for manufacturing a composite electrolyte according to one embodiment of the present disclosure.

FIG. 2 is a scanning electron microscope (SEM) image of the composite electrolyte after removing the eutectic mixture according to one embodiment of the present disclosure.

FIG. 3 is a schematic diagram showing a battery according to one embodiment of the present disclosure.

FIG. 4 shows a charge and discharge test result of the composite electrolyte of Example 1 of the present disclosure.

FIG. 5 shows a charge and discharge test result of the composite electrolyte of Example 2 of the present disclosure.

FIG. 6 shows a charge and discharge test result of the composite electrolyte of Example 3 of the present disclosure.

FIG. 7 shows a charge and discharge test result of the composite electrolyte of Example 4 of the present disclosure.

FIG. 8 shows a charge and discharge test result of the composite electrolyte of Example 5 of the present disclosure.

FIG. 9 shows a charge and discharge test result of the composite electrolyte of Example 6 of the present disclosure.

FIG. 10 shows ionic conductivity test results of the composite electrolytes of Examples 7-9 of the present disclosure.

FIG. 11 shows ionic conductivity test results of the composite electrolytes of Examples 10-12 of the present disclosure.

### DETAILED DESCRIPTION

<Method for Manufacturing Composite Electrolyte>

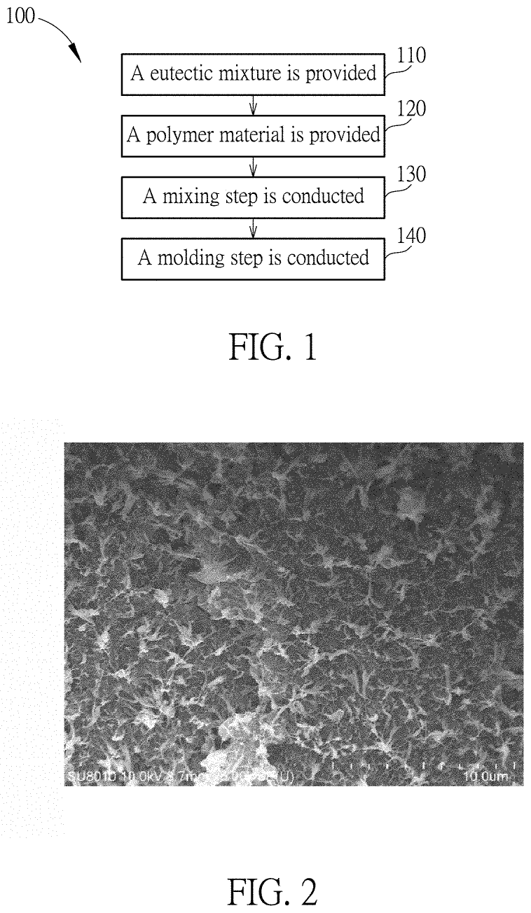

In FIG. 1, a method 100 for manufacturing a composite electrolyte includes Steps 110 to 140. In Step 110, a eutectic mixture is provided, wherein the eutectic mixture includes a lithium salt and a hydrogen-bond donor, and the lithium salt includes a hydrogen-bond acceptor. Specifically, the lithium salt includes a lithium ion and an anion, wherein the anion includes the hydrogen-bond acceptor. The hydrogen-bond acceptor can be the atom with strong electronegative and lone electron pair in the anion. For example, the lithium salt can be lithium bis(trifluoromethanesulfonyl)imide [LiN(CF₃SO₂)₂; LiTFSI] or lithium bis(pentafluoroethanesulfonyl)imide [LiN(C₂F₅SO₂)₂; LIBETI], wherein the groups of CF₃SO₂ and C₂F₅SO₂ includes the hydrogen-bond acceptor. The hydrogen-bond donor can be an amide. The term “amide” refers to a compound having an amide group. For example, the amide can be N-methylacetamide, acetamide, trifluoroacetamide or urea. When mixing the lithium salt and the hydrogen-bond donor, at least one hydrogen bond can be generated therebetween. As such, a melting point of the eutectic mixture is lower than a melting point of the lithium salt and a melting point of the hydrogen-bond donor, which is favorable to reduce the process temperature and enhance the stability. Moreover, the degree of freedom of the migration of the lithium ion can be enhanced. A molar ratio of the lithium salt to the hydrogen-bond donor can range from 5:1 to 1:5.

In Step 120, a polymer material is provided, wherein the polymer material includes a polymer. Specifically, the polymer material can only include the polymer. Alternatively, the polymer material can be a polymer solution formed by mixing the polymer and a solvent. That is, the polymer material can be the polymer itself or the polymer solution. The polymer can be polyvinylidene difluoride (PVDF), polytetrafluoroethylene (PTFE), poly(vinylidene fluoride-co-hexafluoropropylene) (PVDF-HFP), polyethylene oxide (PEO), polyacrylate, polyvinyl acetate (PVAc), poly(vinyl alcohol) (PVA), poly(N-vinylformamide) (PNVF), a copolymer thereof or a combination thereof. The term “polyacrylate” refers to a polymer of an ester derived from acrylic acid or its homologues. For example, the polyacrylate can be, but is not limited to, poly(methyl methacrylate) (PMMA), poly(ethyl methacrylate) or poly(ethyl acrylate). The term “a copolymer thereof” refers to a copolymer polymerized by at least two aforementioned polymers in any ratio. The term “a combination thereof” refers to a blended polymer (polymer mixture) blended by at least two aforementioned polymers in any ratio. The solvent is used to dissolve the polymer and can be selected according to the property of the polymer. The solvent can be, but is not limited to, acetone, DMA (dimethylacetamide), DMF (dimethylformamide), DMSO (dimethyl sulfoxide), NMP (N-methyl-2-pyrrolidone) or acetonitrile. A concentration of the polymer in the polymer solution (polymer material) can range from 1 wt % to 10 wt %. When the concentration of the polymer is too low, such as lower than 1 wt %, the time required to remove the solvent may be increased. When the concentration of the polymer is too high, such as higher than 10 wt %, the formation of gel may occur during the process. The polymer solution (polymer material) can be formed by mixing the polymer and the solvent at a temperature ranging from 40° C. to 100° C. With forming the polymer solution in advance, the mixing homogeneity of the polymer material and the eutectic mixture can be improved. However, the present disclosure is not limited thereto. When the miscibility between the eutectic mixture and the polymer material is high, the solvent can be omitted. Further, the concentration of the polymer and the temperature can be adjusted according the type of the polymer. Moreover, the order of Step 110 and Step 120 can be changed. Alternatively, Step 110 and Step 120 can be conducted simultaneously.

In Step 130, a mixing step is conducted, wherein the eutectic mixture and the polymer material are mixed and heated to form an electrolyte precursor. The temperature of the mixing step can be adjusted according to the type of the eutectic mixture and the polymer material. For example, the mixing step can be conducted at a temperature ranging from 25° C. to 100° C. Preferably, the mixing step can be conducted at a temperature ranging from 40° C. to 100° C. A weight ratio of the polymer to the eutectic mixture can range from 10:90 to 50:50 (That is, based on 100 parts by weight of the eutectic mixture and the polymer material, the content of the polymer is 10 to 50 parts by weight, and the content of the eutectic mixture is 50 to 90 parts by weight). Preferably, the weight ratio of the polymer to the eutectic mixture can range from 15:85 to 30:70.

In Step 140, a molding step is conducted, wherein the electrolyte precursor is cooled to obtain the composite electrolyte. Specifically, when the polymer material only includes the polymer, a colloidal or solid composite electrolyte can be obtained after the electrolyte precursor is cooled. When the polymer material is the polymer solution, the solvent in the electrolyte precursor can be removed first, and the colloidal or solid composite electrolyte can be obtained after the electrolyte precursor is cooled. The solvent in the electrolyte precursor can be removed at a temperature ranging from 25° C. to 70° C. for 1 hour to 48 hours, and the solvent in the electrolyte precursor can be removed under vacuum. The temperature and time for removing the solvent in the electrolyte precursor can be adjusted according the content of the solvent in the electrolyte precursor and the type of the solvent. More specifically, in the molding step, the electrolyte precursor can be injected in a mold, such as a polyethylene mold, then the electrolyte precursor is cooled at a room temperature (when the polymer material only includes the polymer). Alternatively, the electrolyte precursor can be injected in the mold, and then the electrolyte precursor can be placed in a vacuum oven for removing the solvent under vacuum. Afterward, the electrolyte precursor can be taken from the vacuum oven and cooled at a room temperature (when the polymer material is the polymer solution). More specifically, in the molding step, the electrolyte precursor is changed from a fluid state to a gel state or solid state.

Based on the above description, the method 100 for manufacturing the composite electrolyte according to the present disclosure does not require organic solvents conventionally used for lithium-ion batteries, such as EC and PC. Further, the temperature of the mixing step can be less than 100° C., and the final product, i.e., the composite electrolyte does not contain organic solvents. Accordingly, it is favorable to reduce costs and beneficial to environmental protection.

<Composite Electrolyte>

According to the present disclosure, a composite electrolyte is provided. The composite electrolyte is manufactured by the method 100. The composite electrolyte can be solid (in solid state) or colloidal (in gel state). The composite electrolyte includes a eutectic mixture and a polymer, wherein the eutectic mixture is dispersed on the polymer, so that the composite electrolyte has the ability of delivering lithium ions, and can be applied to the field of batteries. Specifically, the polymer can have a network structure, and the eutectic mixture is dispersed in the pores of the network structure. Please refer to FIG. 2, which is a SEM image of the composite electrolyte after removing the eutectic mixture according to one embodiment of the present disclosure. For avoiding polluting the SEM, the eutectic mixture of the composite electrolyte is removed before using a SEM to observe the composite electrolyte. Specifically, the composite electrolyte is cut open and washed with deionized water several times to remove the eutectic mixture. Afterward, the composite electrolyte is dried to remove the moisture, and is observed by the SEM. As shown in FIG. 2, the polymer has a network structure with a plurality of pores inside. The pores are the space where the eutectic mixture originally occupied.

<Battery>

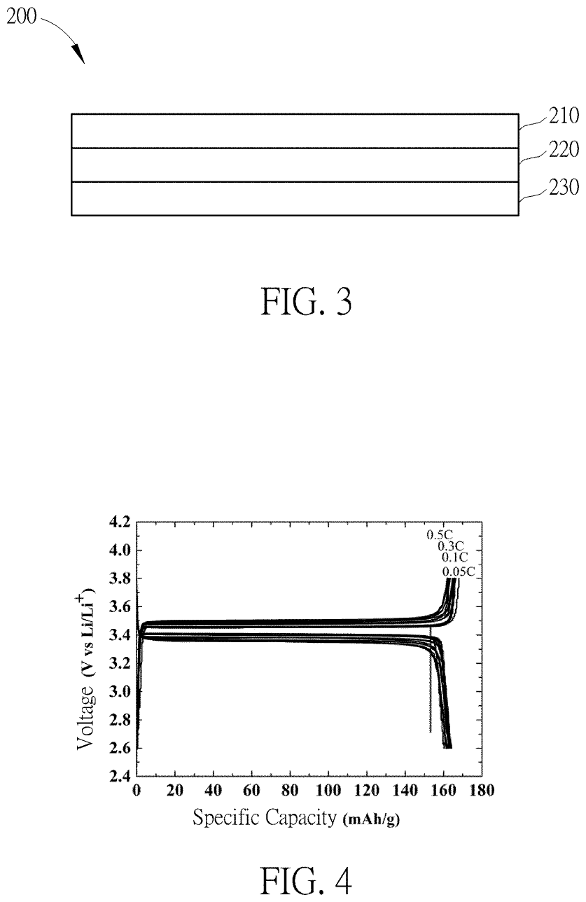

Please refer to FIG. 3. According to the present disclosure, a battery 200 is provided. The battery 200 includes a positive electrode 210, a negative electrode 230 and a composite electrolyte 220. The composite electrolyte 220 is disposed between the positive electrode 210 and the negative electrode 230. Details of the composite electrolyte 220 and method for manufacturing the composite electrolyte 220 can refer to above description and are omitted herein. The material of the positive electrode 210 can be LiCoO₂, LiMn₂O₄, LiNiO₂, LiFePO₄ (LFP), LiFeCoPO₄ or lithium nickel cobalt manganese oxide (NCM or NMC). The material of the negative electrode 230 can be graphite or lithium metal.

### EXAMPLES

Example 1: a eutectic mixture is provided by mixing N-methylacetamide and LiTFSI in a molar ratio of 1:4. A polymer material is provided by mixing PVDF and acetone at 75° C. to form a 5 wt % PVDF solution. The eutectic mixture and the polymer material are mixed and stirred at 75° C. to obtain an electrolyte precursor, wherein a weight ratio of PVDF to the eutectic mixture is 20:80 (i.e., the weight of the eutectic mixture is 4 times the weight of PVDF). The electrolyte precursor is injected in a circular mold made of polyethylene with a diameter of 30 mm. Afterward, the electrolyte precursor with the circular mold is placed in a vacuum oven with a temperature 40° C. under vacuum for 1 day to remove the acetone. Then the electrolyte precursor with the circular mold is taken from the vacuum oven and cooled at room temperature (about 25° C.). As such, the composite electrolyte of Example 1 is obtained.

Examples 2-12: the composite electrolytes of Examples 2-12 are manufactured by replacing the types and ratio of the hydrogen-bond donor, lithium salt, polymer and solvent of Example 1 according to Table 1.

TABLE 1

| Example | 2 | 3 | 4 | 5 | 6 | 7 |
|---|---|---|---|---|---|---|
| hydrogen-bond | N-methyl- | N-methyl- | acetamide | acetamide | N-methyl- | N-methyl- |
| donor | acetamide | acetamide | | | acetamide | acetamide |
| lithium salt | LiTFSI | LiTFSI | LiTFSI | LiTFSI | LiTFSI | LiTFSI |
| molar ratio of | 1:4 | 1:4 | 1:4 | 1:2 | 1:3 | 1:4 |
| the lithium salt | | | | | | |
| to the hydrogen- | | | | | | |
| bond donor | | | | | | |
| polymer | PVDF | PVDF | PVDF | PNVF | PVDF | PVDF |
| | | | | | | blended with |
| | | | | | | 1 wt % |
| | | | | | | PMMA |
| solvent | acetone | acetone | acetone | water | acetone | acetone |
| concentration | 5 wt % | 5 wt % | 5 wt % | 5 wt % | 5 wt % | 5 wt % |
| of polymer | | | | | | |
| solution | | | | | | |
| weight ratio of | 15:85 | 30:70 | 20:80 | 20:80 | 20:80 | 20:80 |
| the polymer to | | | | | | |
| the eutectic | | | | | | |
| mixture | | | | | | |

| Example | 8 | 9 | 10 | 11 | 12 |
|---|---|---|---|---|---|
| hydrogen-bond | N-methyl- | N-methyl- | N-methyl- | N-methyl- | N-methyl- |
| donor | acetamide | acetamide | acetamide | acetamide | acetamide |
| lithium salt | LiTFSI | LiTFSI | LiTFSI | LiTFSI | LiTFSI |
| molar ratio of | 1:4 | 1:4 | 1:4 | 1:4 | 1:4 |
| the lithium salt | | | | | |
| to the hydrogen- | | | | | |
| bond donor | | | | | |
| polymer | PVDF | PVDF | PVDF | PVDF | PVDF |
| | blended with | blended with | blended with | blended with | blended with |
| | 3 wt % | 5 wt % | 5 wt % | 10 wt % | 16 wt % |
| | PMMA | PMMA | PVAc | PVAc | PVAc |
| solvent | acetone | acetone | acetone | acetone | acetone |
| concentration | 5 wt % | 5 wt % | 5 wt % | 5 wt % | 5 wt % |
| of polymer | | | | | |
| solution | | | | | |
| weight ratio of | 20:80 | 20:80 | 20:80 | 20:80 | 20:80 |
| the polymer to | | | | | |
| the eutectic | | | | | |
| mixture | | | | | |

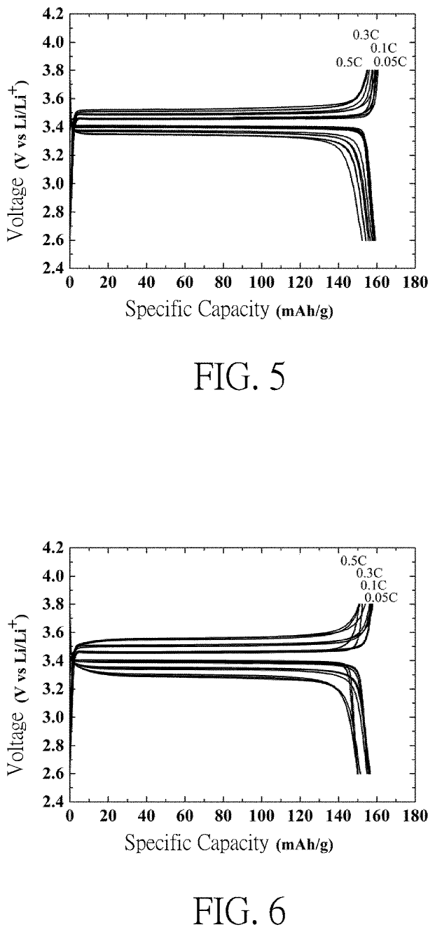

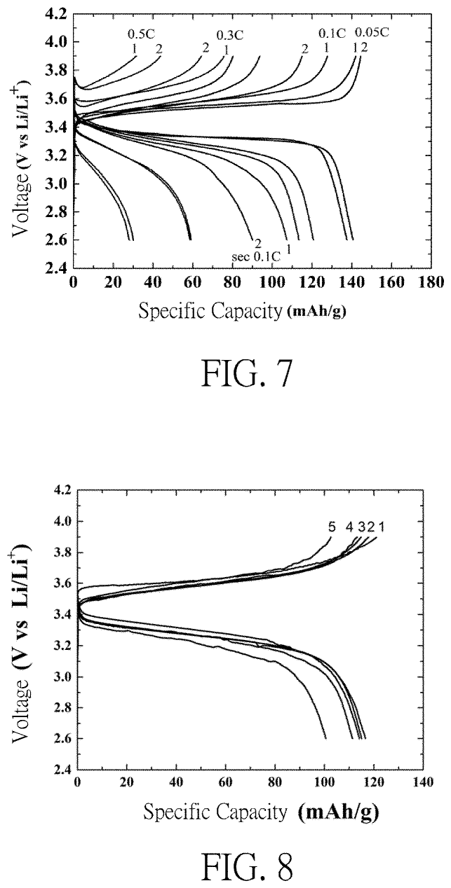

Each of the composite electrolytes of Examples 1-6 is used to assemble a half cell and conduct a charge and discharge test, wherein the material of the positive electrode is LFP, and the material of the negative electrode is graphite. The charge and discharge test results of Examples 1-6 are shown in FIGS. 4-9. As shown in FIGS. 4-9, each of the composite electrolytes of Examples 1 to 6 has the ability of delivering lithium ions, and can be applied to the field of batteries.

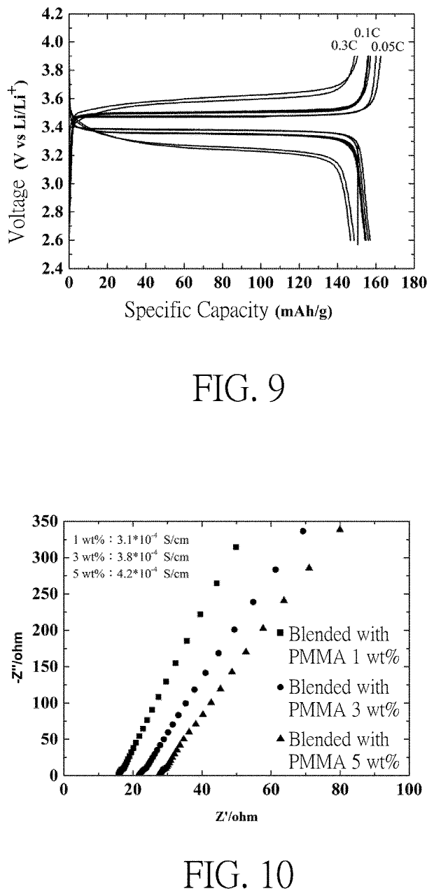

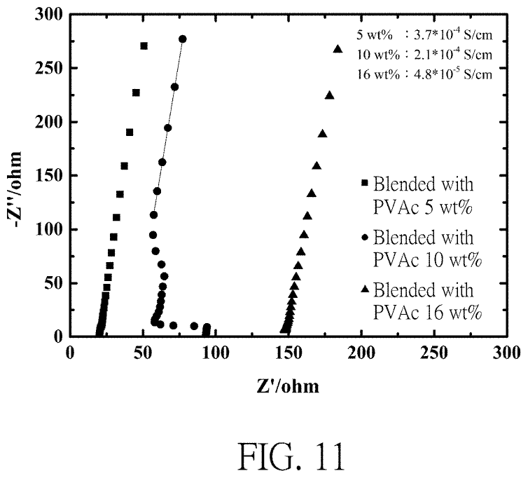

Each of the composite electrolytes of Examples 7-12 is used to conduct an ionic conductivity test. The ionic conductivity test results of Examples 7-12 are shown in FIGS. 10-11. As shown in FIG. 10, when PVDF is blended with 1 wt %-5 wt % PMMA, the ionic conductivity is in the range of 3 0.1×10⁻⁴ S/cm-4.2×10⁻⁴ S/cm. As shown in FIG. 11, when PVDF is blended with 5 wt %-16 wt % PVAc, the ionic conductivity is in the range of 4.8×10⁻⁵ S/cm-3 0.7×10⁻⁴ S/cm. Therefore, the composite electrolyte according to the present disclosure can obtain a required ionic conductivity by selecting different polymers.

The composite electrolyte of Example 1 is further used to assemble the following structure: stainless steel/composite electrolyte/stainless steel, and a linear sweep voltammetry (LSV) test and a cyclic voltammetry (CV) test are conducted. According to the test results, the potential window of Example 1 is 5V.

The composite electrolyte of Example 1 is further used to conduct an ionic conductivity test. According to the test result, the ionic conductivity of Example 1 at room temperature is about 0.5 mS/cm.

The composite electrolyte of Example 1 is further used to conduct a test of lithium ion transference number. According to the test result, the lithium ion transference number of Example 1 is 0.45.

The composite electrolyte of Example 1 is further used to conduct battery cycle life test (0.2 C). According to the test result, after 50 cycles, the capacity is about 99% of original capacity.

The composite electrolyte of Example 1 is further used to conduct a test of limiting oxygen index (LOI). According to the test result, the LOI of Example 1 is 22˜23%, which shows the composite electrolyte of Example 1 has flame resistance, and the safety of the battery having the composite electrolyte of Example 1 is improved.

To sum up, the composite electrolyte according to the present disclosure has the ability of delivering lithium ions, and can be applied to the field of batteries.

Comparing to prior art, the composite electrolyte according to the present disclosure is manufactured by the eutectic mixture and the polymer material, which can avoid organic solvents conventionally used for lithium-ion batteries, such as EC and PC, and is favorable to reduce cost of raw material. Further, with mixing the eutectic mixture and the polymer material, the process temperature and energy consumption can be reduced. As such, the manufacturing costs of the composite electrolyte can be reduced. Accordingly, the manufacturing costs of the battery having the composite electrolyte can also be reduced. Further, the final product, i.e., the composite electrolyte, does not contain organic solvents. Accordingly, it can prevent liquid leakage and environment pollution, which is favorable to enhance the usage safety and is beneficial to the environmental protection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for manufacturing a composite electrolyte, comprising:
providing a eutectic mixture, wherein the eutectic mixture comprises a lithium salt and a hydrogen-bond donor, the lithium salt comprises a hydrogen-bond acceptor;
providing a polymer material, wherein the polymer material comprises a polymer;
conducting a mixing step, wherein the eutectic mixture and the polymer material are mixed and heated to form an electrolyte precursor; and
conducting a molding step, wherein the electrolyte precursor is cooled to obtain the composite electrolyte.

2. The method for manufacturing the composite electrolyte of claim 1, wherein the lithium salt is lithium bis(trifluoromethanesulfonyl)imide or lithium bis(pentafluoroethanesulfonyl)imide.

3. The method for manufacturing the composite electrolyte of claim 1, wherein the hydrogen-bond donor is an amide.

4. The method for manufacturing the composite electrolyte of claim 3, wherein the amide is N-methylacetamide, acetamide, trifluoroacetamide or urea.

5. The method for manufacturing the composite electrolyte of claim 1, wherein a molar ratio of the lithium salt to the hydrogen-bond donor ranges from 5:1 to 1:5.

6. The method for manufacturing the composite electrolyte of claim 1, wherein the polymer is polyvinylidene difluoride, polytetrafluoroethylene, poly(vinylidene fluoride-co-hexafluoropropylene), polyethylene oxide, polyacrylate, polyvinyl acetate, poly(vinyl alcohol), poly(N-vinylformamide), a copolymer thereof or a combination thereof.

7. The method for manufacturing the composite electrolyte of claim 1, wherein a weight ratio of the polymer to the eutectic mixture ranges from 10:90 to 50:50.

8. The method for manufacturing the composite electrolyte of claim 1, wherein the mixing step is conducted at a temperature ranging from 25° C. to 100° C.

9. The method for manufacturing the composite electrolyte of claim 1, wherein the polymer material further comprises a solvent, the polymer material is formed by mixing the polymer and the solvent, the molding step further comprises removing the solvent in the electrolyte precursor before cooling the electrolyte precursor.

10. The method for manufacturing the composite electrolyte of claim 9, wherein the solvent in the electrolyte precursor is removed at a temperature ranging from 25° C. to 70° C. for 1 hour to 48 hours.

11. The method for manufacturing the composite electrolyte of claim 9, wherein the solvent in the electrolyte precursor is removed under vacuum.

12. The method for manufacturing the composite electrolyte of claim 9, wherein the solvent is acetone, dimethylacetamide, dimethylformamide, dimethyl sulfoxide, N-methyl-2-pyrrolidone or acetonitrile.

13. The method for manufacturing the composite electrolyte of claim 9, wherein a concentration of the polymer in the polymer material ranges from 1 wt % to 10 wt %.

14. The method for manufacturing the composite electrolyte of claim 9, wherein the polymer material is formed by mixing the polymer and the solvent at a temperature ranging from 40° C. to 100° C.

15. A composite electrolyte, manufactured by the method of claim 1.

16. A battery, comprising:
a positive electrode;
a negative electrode; and
the composite electrolyte of claim 15 disposed between the positive electrode and the negative electrode.
